(19) United States
(12) Patent Application Publication
(10) Pub. No.: US 2024/0306072 A1
(43) Pub. Date: Sep. 12, 2024

(54) PROXIMITY SERVICE IN RADIO ACCESS NETWORK

(71) Applicant: QUALCOMM Incorporated, San Diego, CA (US)

(72) Inventors: Shuanshuan WU, San Diego, CA (US); Hong CHENG, Basking Ridge, NJ (US)

(21) Appl. No.: 18/181,976

(22) Filed: Mar. 10, 2023

(51) Int. Cl. H04W 40/22; H04W 72/1263

(52) U.S. Cl. CPC H04W 40/22; H04W 72/1263; H04W 84/06

(57) ABSTRACT

Various aspects of the present disclosure generally relate to wireless communication. In some aspects, a user equipment (UE) may transmit, to a network node, a communication associated with an indication that the communication is associated with a proximity service. The UE may communicate based at least in part on the proximity service. Numerous other aspects are described.

### FIELD OF THE DISCLOSURE

Aspects of the present disclosure generally relate to wireless communication and to techniques and apparatuses for proximity services in a radio access network.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

Some aspects described herein relate to a method of wireless communication performed by a user equipment (UE). The method may include transmitting, to a network node, a communication associated with an indication that the communication is associated with a proximity service. The method may include communicating based at least in part on the proximity service.

Some aspects described herein relate to a method of wireless communication performed by a network entity. The method may include receiving a communication associated with a source UE, the communicating being associated with an indication that the communication is associated with a proximity service. The method may include providing the communication for a destination UE, wherein a route for the communication to the destination UE excludes a core network or an application server based at least in part on the indication.

Other aspects provide: an apparatus operable, configured, or otherwise adapted to perform any one or more of the aforementioned methods and/or those described herein with reference to and as illustrated by the drawings; a non-transitory, computer-readable medium comprising computer-executable instructions that, when executed by a processor of an apparatus, cause the apparatus to perform the aforementioned methods and/or those described herein with reference to and as illustrated by the drawings; a computer program product embodied on a computer-readable storage medium comprising code for performing the aforementioned methods and/or those described herein with reference to and as illustrated by the drawings; and/or an apparatus comprising means for performing the aforementioned methods and/or those described herein with reference to and as illustrated by the drawings. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station (BS) and user equipment (UE), in accordance with the present disclosure.

FIG. 3 depicts an example disaggregated base station architecture.

FIGS. 4A, 4B, 4C, and 4D depict aspects of data structures for a wireless communications network in accordance with the present disclosure.

FIG. 5 is a diagram illustrating an example of a regenerative satellite deployment and an example of a transparent satellite deployment in a non-terrestrial network.

FIG. 6 is a diagram illustrating an example of signaling for local routing of communications, in accordance with the present disclosure.

FIG. 7 shows a method for wireless communications by a UE.

FIG. 8 shows a method for wireless communications by a network entity.

FIG. 9 is a diagram illustrating an example of an implementation of code and circuitry for a communications device, in accordance with the present disclosure.

FIG. 10 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for proximity services in a radio access network, such as a non-terrestrial network.

A user equipment (UE) may provide radio access, vehicle-to-vehicle communication, and/or other services for a vehicle, such as a connected vehicle. For example, an on-board unit (OBU) of the vehicle may comprise a UE. One example of a service which may be supported by a UE (such as a UE associated with an OBU of a vehicle) is a proximity service. A proximity service may provide for a UE to obtain information regarding surroundings, such as presence or status of nearby vehicles, vulnerable road users, and so on. In some examples, communication for proximity services may be performed using sidelink signaling (e.g., directly between UEs or other network nodes in proximity to a UE). In some other examples, communication for a proximity service may be performed via a radio access link (e.g., a Uu interface, an uplink, a downlink, a service link) between the UE and a network node. The network node can be a terrestrial network node (e.g., a terrestrial base station or entity of a disaggregated base station) or a non-terrestrial network (NTN) node. NTN nodes are associated with higher latency and round-trip time than terrestrial network nodes, due to the larger distances between the NTN node and source or destination UEs and the potential involvement of a gateway, separate from a satellite, via which communications may be routed in NTN communication.

The larger latency and round-trip time (particularly for communications that are routed via a core network or application server during provision by an NTN node) may reduce the accuracy and usability of a proximity service, or may violate latency thresholds of the proximity service. Furthermore, different network nodes (such as different NTN nodes) may have different capabilities, ranging from full-protocol-stack capabilities (such as when the full functionality of a gNB is included in a network node) to transparent, physical-layer-only capabilities (such as when the network node is a transparent satellite of an NTN system). These differences in capabilities may impact the network node's abilities for routing or detecting communications associated with proximity services, leading to an inability to detect that a particular communication is associated with a routing service or increased overhead associated with indicating that the particular communication is associated with the routing service.

Some techniques described herein provide transmission, by a source UE, of a communication associated with a proximity service. The communication may be associated with an indication. The indication may indicate that the communication is associated with the proximity service. This indication may enable a network node to identify that the communication is associated with the proximity service, thereby enabling local routing of the communication.

A network node may provide the communication for a destination UE. A route for the communication to the destination UE may exclude a core network or an application server based at least in part on the indication. For example, the network node may perform local routing of the communication. In this way, the latency and round-trip time commonly associated with communication (particularly NTN communication) may be reduced, thereby improving accuracy and usability of a proximity service and/or ensuring that latency thresholds of the proximity service are satisfied. In some aspects, the source UE may receive information indicating a configuration for the indication, which may include information regarding the network node (such as whether the network node is a regenerative satellite or a transparent satellite, or whether the network node includes a central unit), which enables support for multiple different types of indication (depending, for example, on the information regarding the network node).

In some examples, the indication may comprise a resource on which the communication is transmitted, which enables a lower-capability network node (such as a transparent satellite) to identify that a communication is associated with the proximity service and which may reduce overhead relative to providing more complex signaling. In some aspects, the indication may comprise a packet type of the communication, which may enable a network node having a threshold capability (such as including a central unit or distributed unit, or implementing a full protocol stack) to identify the indication without the overhead incurred from separate signaling.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

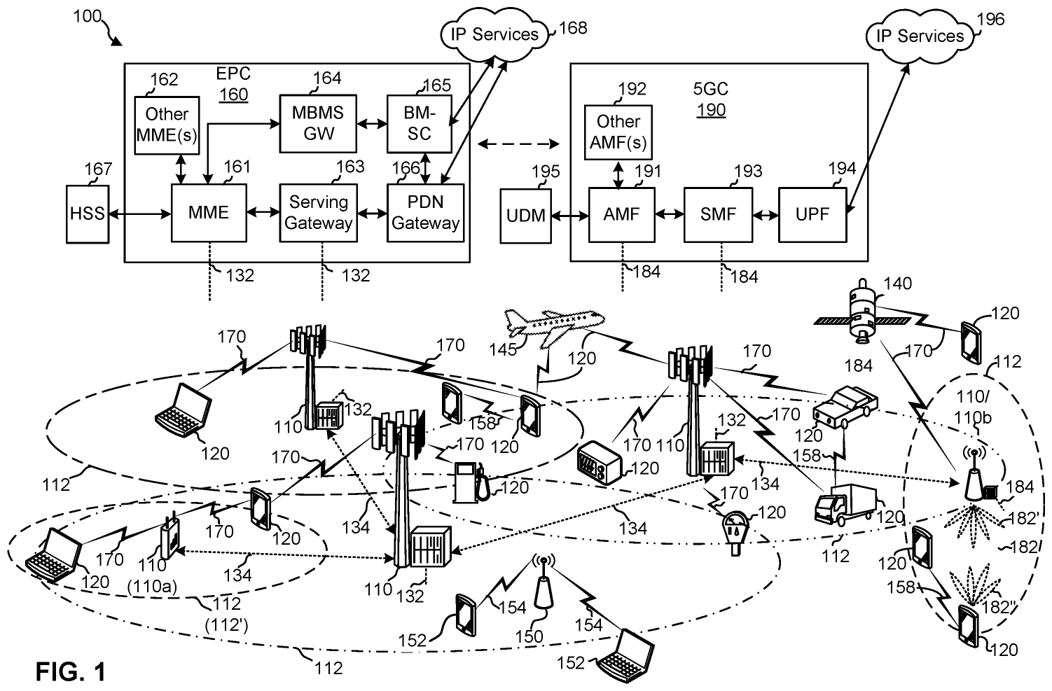

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a UE, a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

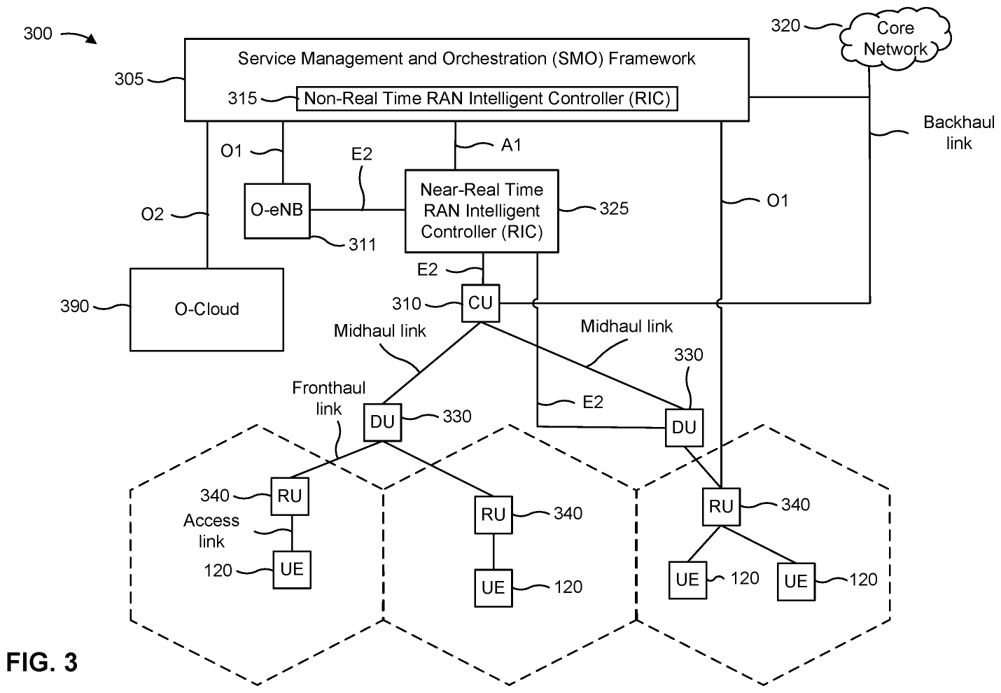

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182′′. UE 120 may also transmit a beamformed signal to the BS 110b in one or more transmit directions 182′′. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

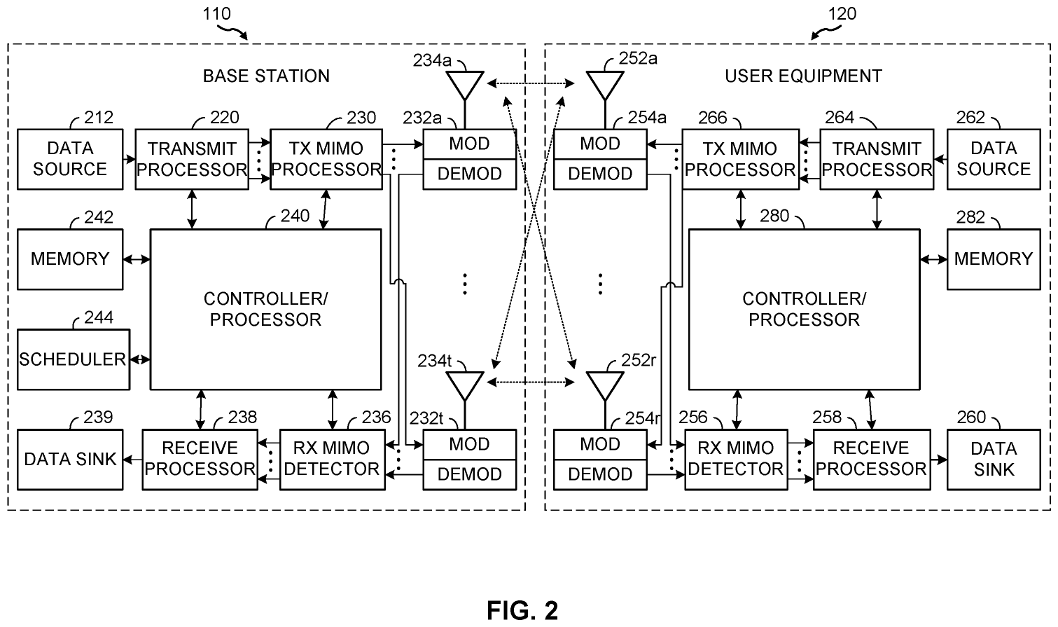

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) MIMO processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

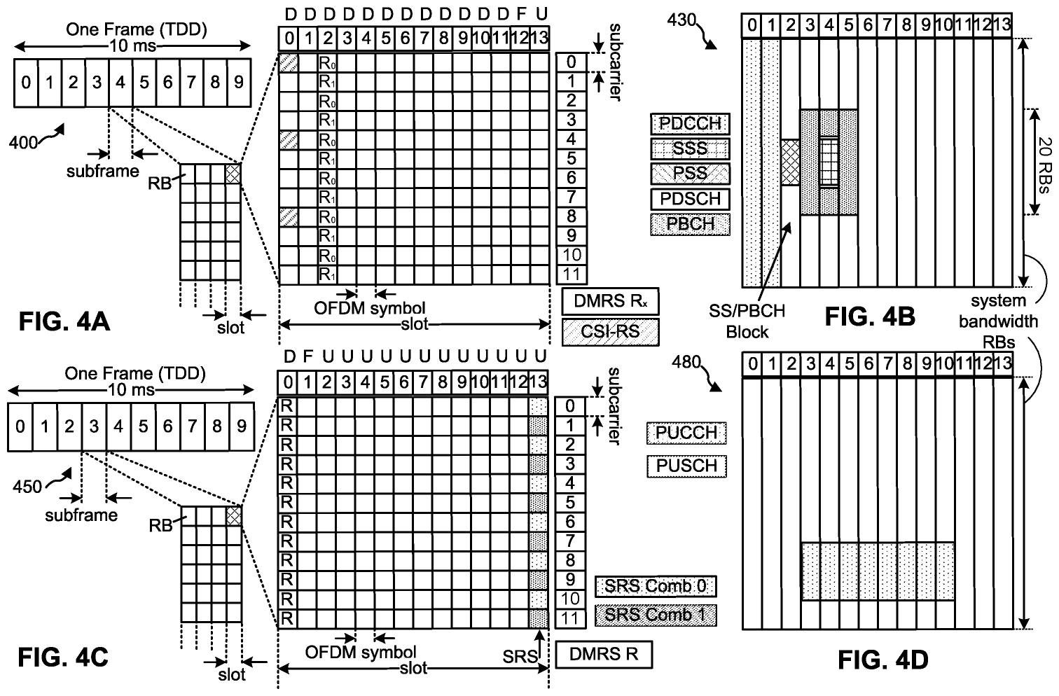

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe.

For slot configuration 1, different numerologies 0 to 2 allow for 2, 4, and 8 slots, respectively, per subframe. Accordingly, for slot configuration 0 and numerology μ, there are 14 symbols/slot and 2^{μ}=0 slots/subframe. The subcarrier spacing and symbol length/duration are a function of the numerology. The subcarrier spacing may be equal to 2^{μ}×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (SSB). The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the physical uplink shared channel (PUSCH). The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

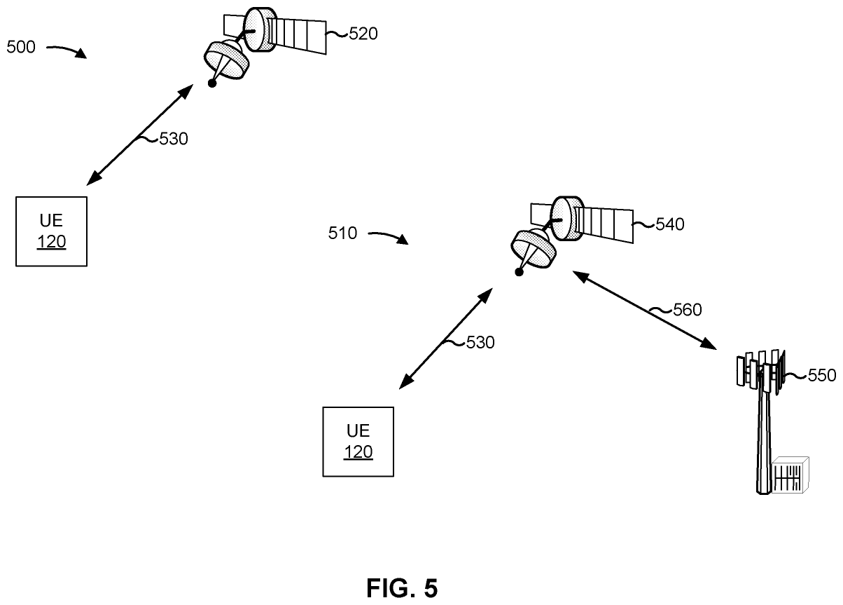

FIG. 5 is a diagram illustrating an example 500 of a regenerative satellite deployment and an example 510 of a transparent satellite deployment in a non-terrestrial network.

Example 500 shows a regenerative satellite deployment. In example 500, a UE 120 is served by a satellite 520 via a service link 530. For example, the satellite 520 may include a BS 110 (e.g., BS 110a) or a gNB. In some aspects, the satellite 520 may be referred to as a non-terrestrial network node, a non-terrestrial base station, a regenerative repeater, or an on-board processing repeater. In some aspects, the satellite 520 may demodulate an uplink radio frequency signal, and may modulate a baseband signal derived from the uplink radio signal to produce a downlink radio frequency transmission. The satellite 520 may transmit the downlink radio frequency signal on the service link 530. The satellite 520 may provide a cell that covers the UE 120. In some aspects, a satellite 520 may be capable of determining a packet type of a communication. In some aspects, a satellite 520 may be capable of receiving and processing MAC and/or RRC signaling, such as from a UE 120. In some aspects, a satellite 520 may include a gNB (e.g., a CU, a DU, and an RU, as described in connection with FIGS. 1-3). For example, the satellite 520 may implement a full NR protocol stack. In some other aspects, a satellite 520 may include one or more network functions of a gNB, such as one or more DUs and/or one or more RUs. In some aspects, a satellite 520 may be associated with a gateway (e.g., gateway 550).

Example 510 shows a transparent satellite deployment, which may also be referred to as a bent-pipe satellite deployment. In example 510, a UE 120 is served by a satellite 540 via the service link 530. The satellite 540 may be a transparent satellite. The satellite 540 may relay a signal received from gateway 550 via a feeder link 560. For example, the satellite 540 may receive an uplink radio frequency transmission, and may transmit a downlink radio frequency transmission without demodulating the uplink radio frequency transmission. In some aspects, the satellite 540 may frequency convert the uplink radio frequency transmission received on the service link 530 to a frequency of the uplink radio frequency transmission on the feeder link 560, and may amplify and/or filter the uplink radio frequency transmission. In some aspects, the UEs 120 shown in example 500 and example 510 may be associated with a Global Navigation Satellite System (GNSS) capability or a GPS capability, though not all Ues have such capabilities. The satellite 540 may provide a cell that covers the UE 120. In some aspects, the satellite 540 may include radio functionality of a gNB (e.g., one or more RUs). In some aspects, the satellite 540 may not include one or more layers of the NR protocol stack, such as one or more layers that may be implemented at a DU or a CU (e.g., the MAC layer, the RRC layer, the non-access stratum layer). Thus, a satellite 540 may typically perform physical-layer operations such as radio transmission and reception, whereas a satellite 520 may perform higher-layer operations in addition to or as an alternative to the physical-layer operations.

The service link 530 may include a link between the satellite 540 and the UE 120, and may include one or more of an uplink or a downlink. The feeder link 560 may include a link between the satellite 540 and the gateway 550, and may include one or more of an uplink (e.g., from the UE 120 to the gateway 550) or a downlink (e.g., from the gateway 550 to the UE 120). An uplink of the service link 530 may be indicated by reference number 530-U (not shown in FIG. 5) and a downlink of the service link 530 may be indicated by reference number 530-D (not shown in FIG. 5). Similarly, an uplink of the feeder link 560 may be indicated by reference number 560-U (not shown in FIG. 5) and a downlink of the feeder link 560 may be indicated by reference number 560-D (not shown in FIG. 5). As used herein, “NTN node” can refer to satellite 520, satellite 540, or gateway 550.

The feeder link 560 and the service link 530 may each be associated with a propagation delay, which may be a function of the speed of light and the signal path of the feeder link 560 and the service link 530. Furthermore, in some cases, a communication may be routed from a source node (e.g., UE) to a destination node (e.g., UE) in addition to propagating on the service link 530 and potentially the feeder link 560. This may lead to significant round-trip time or latency, particularly for communications that originate at a source UE 120, are transmitted to a satellite 520/540 via a service link 530, and are then routed to a destination UE 120 via at least one of a feeder link 560, a gateway 550, a core network, or another satellite. Some techniques described herein provide local routing of communications by an NTN node (such as the satellite 520, the satellite 540, or the gateway 550). The local routing may provide for the communications to be routed from the source UE to the destination UE by the NTN network node, such as without being provided via an application server or a core network of the NTN node. Thus, latency and/or round trip time are reduced.

As indicated above, FIG. 5 is provided as an example. Other examples may differ from what is described with regard to FIG. 5.

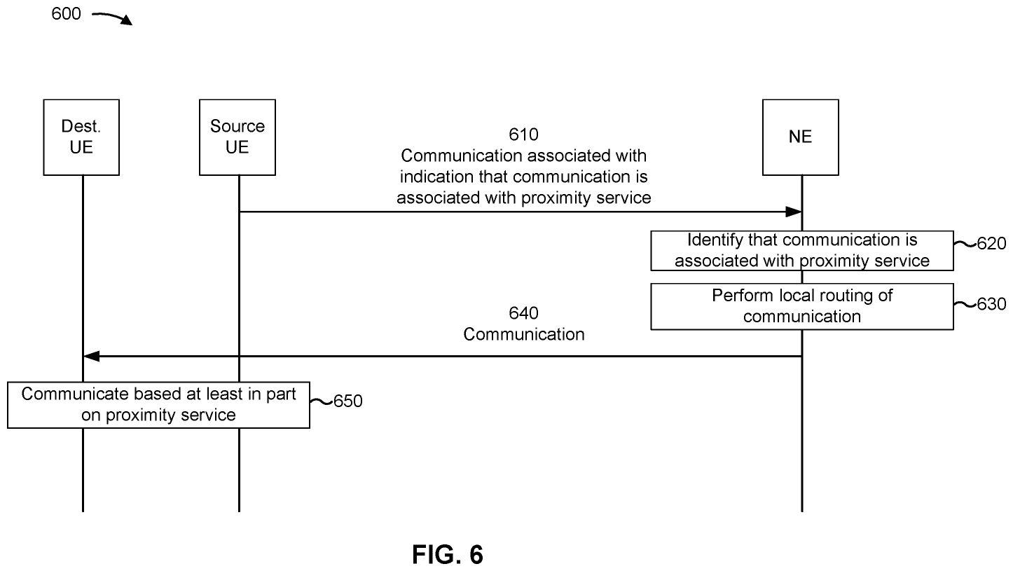

FIG. 6 is a diagram illustrating an example 600 of signaling for local routing of communications, in accordance with the present disclosure. As shown, example 600 includes a source UE (e.g., UE 120), a destination UE (e.g., UE 120), and a network entity (e.g., network entity, satellite 520, satellite 540, gateway 550).

As shown in FIG. 6, and by reference number 610, the source UE may transmit, and the network entity may receive, a communication. As further shown, the communication may be associated with an indication that the communication is associated with a proximity service. The communication may be associated with the proximity service in that the communication is part of the proximity service, carries information related to the proximity service, or includes a message defined as part of a proximity service. In some aspects, the communication may include the indication. In some aspects, the source UE may transmit the indication separately from the communication. The source UE may transmit the communication via a radio access link, such as service link 530 on the uplink, using a Uu interface. In some aspects, the source UE may provide information indicating a packet delay budget of the communication. In some aspects, the source UE may not provide the indication. In some aspects, the indication may include a request for the network entity to perform local routing.

In some aspects, the indication may comprise a packet type (e.g., information other than an Internet Protocol address) of the communication. This may be referred to herein as Option 1. For example, a PDCP service data unit (SDU) type field of the communication may include the indication of the packet type. The PDCP SDU type field may include a number of bits (e.g., 3 bits). A value of the bits (e.g., a value selected from 010 through 111, in just one example) may indicate that the communication is associated with the proximity service.

In some aspects, the indication may be included in the communication. This may be referred to herein as Option 2. For example, the indication may be information, or may be based at least in part on information, included in the communication, such as MAC layer information. In some aspects, the MAC layer information may include a MAC CE, identified by one or more dedicated logical channel identifiers (LCIDs). For example, the MAC CE may be transmitted with a MAC SDU that carries the communication (e.g., a packet for the proximity service). Alternatively, the MAC layer information may explicitly indicate that a given transport block is associated with the proximity service. For example, the given transport block may be, may be part of, or may carry the communication. In some aspects, one or more LCIDs may be dedicated to indicate that a packet (e.g., a communication from the source UE) is associated with the proximity service or is to be locally routed. For example, the communication may include or be associated with a MAC subheader of a MAC SDU that indicates an LCID of the one or more LCIDs.

In some aspects, the indication may be associated with the communication. For example, the indication may be, may include, or may be included in a BSR that requests a resource allocation for uplink transmission of the communication. In some aspects, the source UE may transmit the indication separately from the communication. For example, the source UE may transmit RRC signaling or another form of signaling indicating that a communication (e.g., a resource associated with the communication) is for the proximity service.

In some aspects, the indication may comprise a resource on which the communication is transmitted (or received). This may be referred to herein as Option 3. For example, one or more time resources (e.g., slots) and/or frequency resources (e.g., PRBs) may be allocated or configured (such as via configuration information, system information, dynamic signaling, or the like) as resources that indicate that a communication is associated with a proximity service. If the communication is transmitted on such a resource, the network entity may perform local routing of the communication, as described below. For example, the network entity may configure a set of slots as a resource pool (e.g., on the uplink) for transmissions associated with proximity services. If the communication is associated with the proximity service, the source UE may transmit the communication on a resource of the set of resources. In some aspects, the network entity may schedule the communication on a resource indicating that the communication is associated with the proximity service. For example, the network entity may schedule the communication on the resource indicating that the communication is associated with the proximity service in response to signaling from the UE (such as a BSR or an RRC message) indicating that a communication is for the proximity service.

A network entity having a full protocol stack (such as a regenerative satellite) may be capable of determining that a communication is associated with a proximity service using Option 1, Option 2, or Option 3. A network entity having a partial protocol stack (e.g., a network entity having a DU functionality and not a CU functionality, such as a satellite with an onboard DU) may be capable of determining that a communication is associated with a proximity service using Option 2 or Option 3. For a network entity having a partial protocol stack to determine that a communication is associated with a proximity service using Option 1, the network entity may provide the communication to another network entity, such as a CU and/or a gateway. A transparent satellite (which may be an example of a network entity having only physical-layer capabilities and/or excluding a DU) may be capable of determining that a communication is associated with a proximity service using Option 3. For a network entity having only physical-layer capabilities to determine that a communication is associated with a proximity service using Option 1 or Option 2, the network entity may provide the communication to another network entity, such as a CU and/or a gateway.

In some aspects, the network entity (or another network entity) may transmit, and the UE may receive, a configuration for the indication. For example, the configuration may include information indicating whether to provide the indication in accordance with Option 1, Option 2, or Option 3. For example, more than one form of indication (of Option 1, Option 2, or Option 3) may be supported. In some aspects, the information may indicate whether the network entity is a regenerative satellite or a transparent satellite. Additionally or alternatively, the information may indicate whether the network entity has a full protocol stack or a partial protocol stack (such as whether the network entity includes a full gNB and/or CU, or whether the network entity includes a DU and not a CU). In some aspects, the network entity (or another network entity) may transmit, and the source UE may receive, information indicating whether local routing for the proximity service (e.g., a particular proximity service or any proximity service) is supported. The source UE may transmit the communication and/or the indication in accordance with the information indicating whether to provide the indication in accordance with Option 1, Option 2, or Option 3, and/or the information indicating whether local routing for the proximity service is supported.

As shown by reference number 620, the network entity may identify that the communication is associated with the proximity service. For example, the network entity may determine that the communication is associated with the proximity service according to the indication. In some aspects, the network entity may determine that the communication is associated with the proximity service because the packet type of the communication is a packet type that corresponds to proximity services. In some aspects, the network entity may determine that the communication is associated with the proximity service because signaling, separate from or included in the communication, indicates that the communication is associated with the proximity service. In some aspects, the network entity may perform local routing of the communication without determining that the communication is associated with the proximity service. For example, the network entity may automatically perform local routing of communications received or transmitted on a particular resource irrespective of whether the communication is associated with the proximity service.

In some aspects, the network entity (e.g., a satellite) may provide the communication to a ground station of an NTN (e.g., a gateway). The ground station may identify the communication as associated with the proximity service (e.g., for ProSe) and may transmit the communication back to the satellite via a feeder link with the satellite (e.g., for local routing to the destination UE). This may enable implementation of local routing for transparent satellites without dedicated resources, and may reduce latency relative to routing via the core network.

In some aspects, the network entity may determine to perform local routing without having received an indication. For example, the network entity may be aware of latency for a communication for which local routing is not performed (e.g., a packet routed to a core network and/or application server). The network entity may determine to perform local routing of a communication if the latency exceeds a threshold, such as a latency threshold or a packet delay budget, associated with the communication.

As shown by reference number 630, the network entity may perform local routing of the communication based at least in part on the indication (or in the absence of the indication, if no indication is provided). “Local routing” may include providing the communication for a destination UE (e.g., directly to the destination UE or to one or more other nodes en route to the destination UE) without routing the communication via one or more of a core network or an application server (e.g., a proximity service application server). For example, the network entity may provide the communication without the communication being routed via an application server. As another example, the network entity may provide the communication without the communication being routed via a core network entity. As another example, the network entity (e.g., satellite 520) may provide the communication without the communication being routed via a gateway (e.g., gateway 550). As another example, the network entity may provide the communication without the communication being routed via two or more of a gateway, a core network entity, or an application server.

In some aspects, the network entity may be a regenerative satellite, and may provide local routing for a proximity service. For example, the network entity may determine that a received packet from a source UE, on a service link uplink, is to be routed to one or more destination UE(s) locally (e.g., according to Option 1 or Option 2). The network entity may transmit the packet on a service link downlink to the one or more destination UEs (such as without routing the packet to the ground station). For example, the network entity may receive a packet for a proximity service in slot n on a service link uplink. Upon determining that the packet is for the proximity service, the network entity may transmit the packet in slot n+k on a service link downlink, where k>0. In some aspects, from a physical-layer perspective, transmission from the network entity to the UE may be a regular downlink transmission in service link. In some aspects, the network entity may perform local routing by default if a received packet is identified as for a proximity service. Alternatively, the source UE may explicitly request local routing (e.g., indicated via BSR or a MAC CE), and the network entity may perform local routing only if the source UE has requested local routing.

In some aspects, the network entity may be a regenerative satellite (e.g., that does not include or omits a CU), and may provide local routing for a proximity service. For example, the network entity may be implemented based on a CU-DU split, where a CU is implemented in a ground station (e.g., gateway) while a DU is on-board the satellite. Depending on implementation options, the DU may have some functionalities or protocol layers of a gNB (e.g., MAC, RLC, a scheduler). The network entity DU may determine that a received packet from a source UE on a service link uplink is to be routed to one or more destination UEs locally (e.g., based on Option 2). The network entity DU may transmit the packet to the one or more destination UEs on a service link downlink.

In some aspects, the network entity may be a transparent satellite (e.g., which may have limited processing functionality, as described elsewhere herein). Generally, a transparent satellite may receive a signal on one link (e.g., the service link), and may perform radio frequency filtering, frequency conversion, and amplification. The satellite may then transmit the signal on the other link (e.g., feeder link). To perform local routing, a transparent satellite may receive a communication in a resource indicating that the communication is associated with local routing. The resource may be included in a resource pool configured for the source UE to transmit uplink transmissions carrying packets (e.g., communications) for a proximity service. The transparent satellite may forward the communication on a service link downlink (e.g., to a destination UE). In some aspects, the satellite may perform signal processing (including one or more of radio frequency filtering, frequency conversion (from an uplink frequency to a downlink frequency), or amplification), and may transmit the communication on the service link downlink after a delay. For example, the delay may be configured or indicated by a network entity. The delay may provide for a signal, forwarded on the service link downlink, to be aligned with a downlink slot boundary of the service link downlink. For example, a signal sent or received in slot n on a service link uplink may be forwarded by a transparent satellite in slot n+k on a service link downlink.

In some aspects, the source UE may transmit the communication on a resource scheduled by a configured grant, which may reduce latency by reducing dynamic interaction between the source UE and a network entity associated with the satellite (such as a ground station). A destination UE receiving the communication (e.g., in the downlink) may additionally or alternatively be scheduled by a configured grant, which may also reduce latency. For example, the network entity may transmit the configured grant for the UE.

In some aspects, transmission of the communication by the source UE and forwarding of the communication by the destination UE may use a common waveform (e.g., the same waveform, a similar waveform). For example, a common waveform may be used for proximity service packet transmission. In one example, the common waveform may be a sidelink waveform.

In some aspects, the network entity may transmit the communication to the destination UE using a same beam as is used for downlink communication with the source UE. The network entity may be capable of using multiple different downlink beams (e.g., different beam used to transmit downlink communications). For local routing (e.g., when the indication indicates that the communication is associated with a proximity service), the network entity may transmit the communication using a downlink beam that is associated with downlink communication with the source UE. Thus, complexity of forwarding the communication is reduced.

As shown by reference number 640, the destination UE may receive the communication. As shown by reference number 650, the source UE, the destination UE, and/or the network entity may communicate based at least in part on the proximity service. For example, the source UE and the network UE may exchange information (e.g., one or more proximity service messages, which may or may not include the communication shown by reference number 610). As another example, the destination UE may acknowledge the communication and/or may transmit a communication to the source UE (directly or via the network entity) or the network entity.

As indicated above, FIG. 6 is provided as an example. Other examples may differ from what is described with regard to FIG. 6.

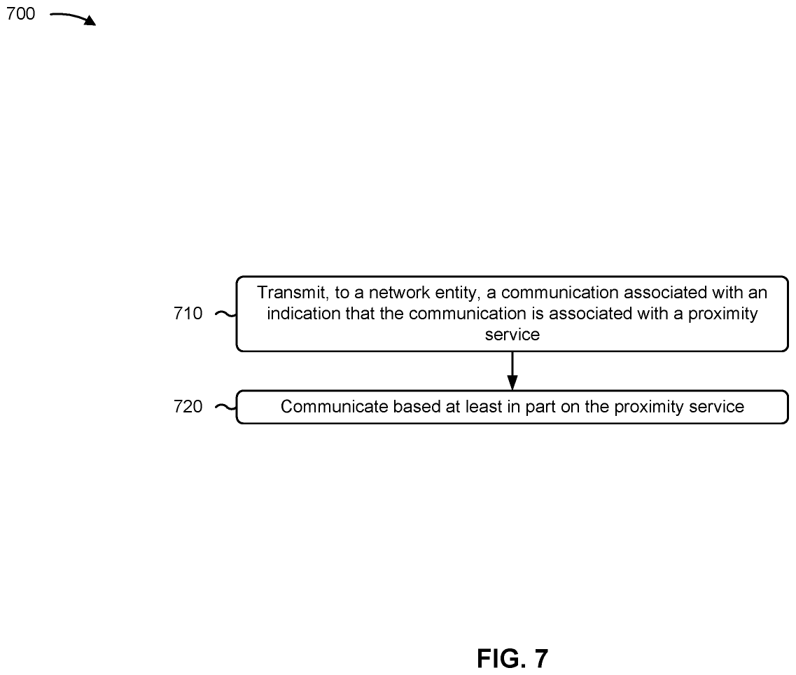

FIG. 7 shows a method 700 for wireless communications by a UE, such as UE 120.

Method 700 begins at 710 with transmitting, to a network entity, a communication associated with an indication that the communication is associated with a proximity service.

Method 700 then proceeds to step 720 with communicating based at least in part on the proximity service.

In a first aspect, the indication comprises a packet type of the communication.

In a second aspect, alone or in combination with the first aspect, the indication comprises a medium access control or radio resource control layer indication.

In a third aspect, alone or in combination with one or more of the first and second aspects, the indication comprises a resource on which the communication is transmitted.

In a fourth aspect, alone or in combination with one or more of the first through third aspects, method 700 includes receiving a configured grant indicating the resource.

In a fifth aspect, alone or in combination with one or more of the first through fourth aspects, method 700 includes receiving a configuration of a resource pool, and transmitting the indication on a resource included in the resource pool.

In a sixth aspect, alone or in combination with one or more of the first through fifth aspects, method 700 includes receiving information indicating a configuration for the indication.

In a seventh aspect, alone or in combination with one or more of the first through sixth aspects, the information indicating the configuration indicates at least one of whether the network entity is a regenerative satellite or a transparent satellite, whether the network entity includes a central unit, whether local routing is supported for the proximity service, or a type of the local routing.

In an eighth aspect, alone or in combination with one or more of the first through seventh aspects, the indication includes a request for the network entity to perform local routing of the communication.

In a ninth aspect, alone or in combination with one or more of the first through eighth aspects, the communication indicates a packet delay budget of the communication.

In a tenth aspect, alone or in combination with one or more of the first through ninth aspects, the indication comprises a buffer status request for a resource for the communication.

Although FIG. 7 shows example blocks of method 700, in some aspects, method 700 may include additional blocks, fewer blocks, different blocks, or differently arranged blocks than those depicted in FIG. 7. Additionally, or alternatively, two or more of the blocks of method 700 may be performed in parallel.

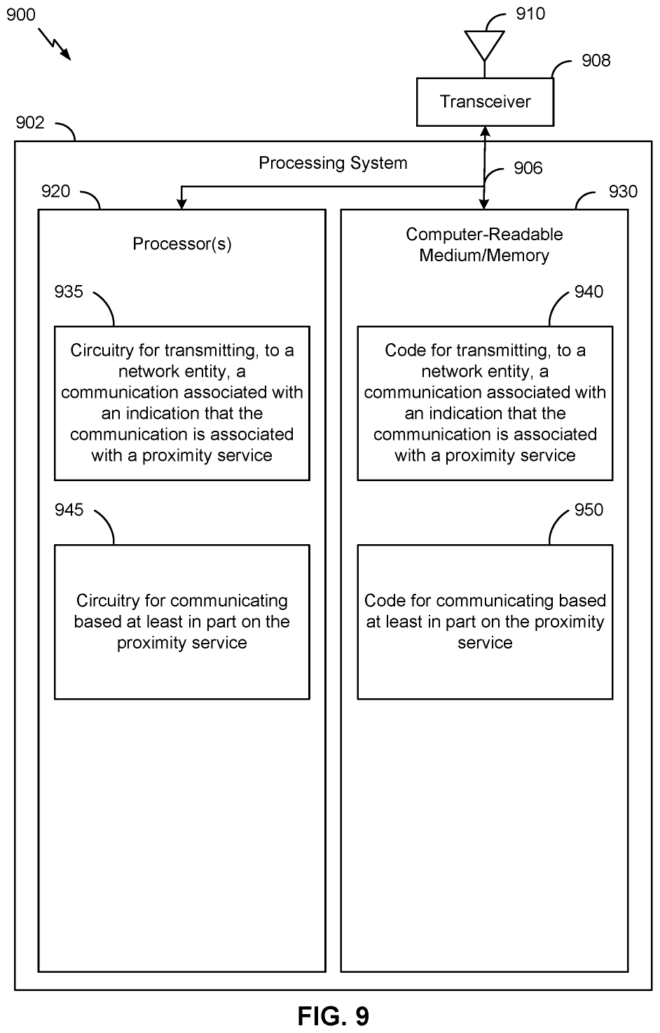

In one aspect, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative steps are possible consistent with this disclosure.

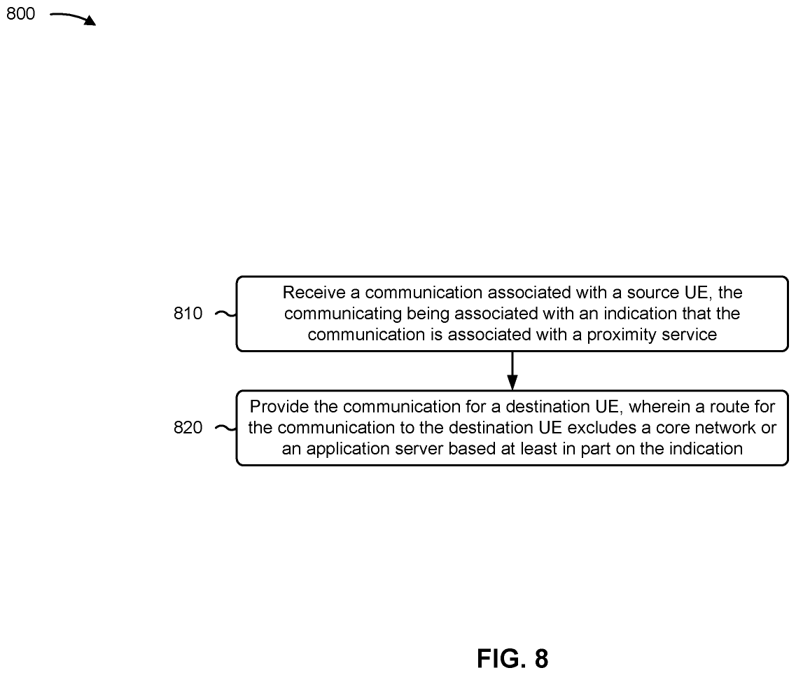

FIG. 8 shows a method 800 for wireless communications by a network entity, such as BS 110, or a disaggregated base station as discussed with respect to FIG. 3.

Method 800 begins at 810 with receiving a communication associated with a source UE, the communicating being associated with an indication that the communication is associated with a proximity service.

Method 800 then proceeds to step 820 with providing the communication for a destination UE, wherein a route for the communication to the destination UE excludes a core network or an application server based at least in part on the indication.

In a first aspect, the network entity comprises a satellite.

In a second aspect, alone or in combination with the first aspect, the satellite includes a distributed unit, and wherein providing the communication for the destination UE comprises providing the communication via a service link downlink of the satellite.

In a third aspect, alone or in combination with one or more of the first and second aspects, the satellite includes a central unit.

In a fourth aspect, alone or in combination with one or more of the first through third aspects, providing the communication comprises providing the communication on a downlink beam of the source UE.

In a fifth aspect, alone or in combination with one or more of the first through fourth aspects, the network entity comprises a gateway.

In a sixth aspect, alone or in combination with one or more of the first through fifth aspects, receiving the communication further comprises receiving the communication on a feeder link, and wherein providing the communication further comprises providing the communication on the feeder link.

In a seventh aspect, alone or in combination with one or more of the first through sixth aspects, the indication comprises a packet type of the communication.

In an eighth aspect, alone or in combination with one or more of the first through seventh aspects, the indication comprises a MAC layer indication.

In a ninth aspect, alone or in combination with one or more of the first through eighth aspects, the indication comprises a resource on which the communication is transmitted.

In a tenth aspect, alone or in combination with one or more of the first through ninth aspects, method 800 includes transmitting a configuration of a resource pool including the resource, wherein the resource pool is for transmission of the indication.

In an eleventh aspect, alone or in combination with one or more of the first through tenth aspects, method 800 includes transmitting a configured grant indicating the resource.

In a twelfth aspect, alone or in combination with one or more of the first through eleventh aspects, method 800 includes transmitting, for the destination UE, a configured grant for reception of the communication.

In a thirteenth aspect, alone or in combination with one or more of the first through twelfth aspects, method 800 includes transmitting information indicating a configuration for the indication.

In a fourteenth aspect, alone or in combination with one or more of the first through thirteenth aspects, the information indicating the configuration indicates at least one of whether the network entity is a regenerative satellite or a transparent satellite, whether the network entity includes a central unit, whether local routing is supported for the proximity service, or a type of the local routing.

In a fifteenth aspect, alone or in combination with one or more of the first through fourteenth aspects, the indication includes a request for the network entity to perform local routing of the communication, wherein the route for the communication to the destination UE excludes the core network or the application server in accordance with the request.

In a sixteenth aspect, alone or in combination with one or more of the first through fifteenth aspects, the communication indicates a packet delay budget of the communication, wherein the route for the communication to the destination UE excludes the core network or the application server in accordance with the packet delay budget.

In a seventeenth aspect, alone or in combination with one or more of the first through sixteenth aspects, the communication as received by the network entity and the communication as provided by the network entity use a common waveform.

In an eighteenth aspect, alone or in combination with one or more of the first through seventeenth aspects, providing the communication further comprises providing the communication in accordance with a configured delay.

In a nineteenth aspect, alone or in combination with one or more of the first through eighteenth aspects, the indication comprises a buffer status report, wherein the method further comprises receiving the buffer status report prior to the communication, and scheduling the source UE to transmit the communication in accordance with the buffer status report.

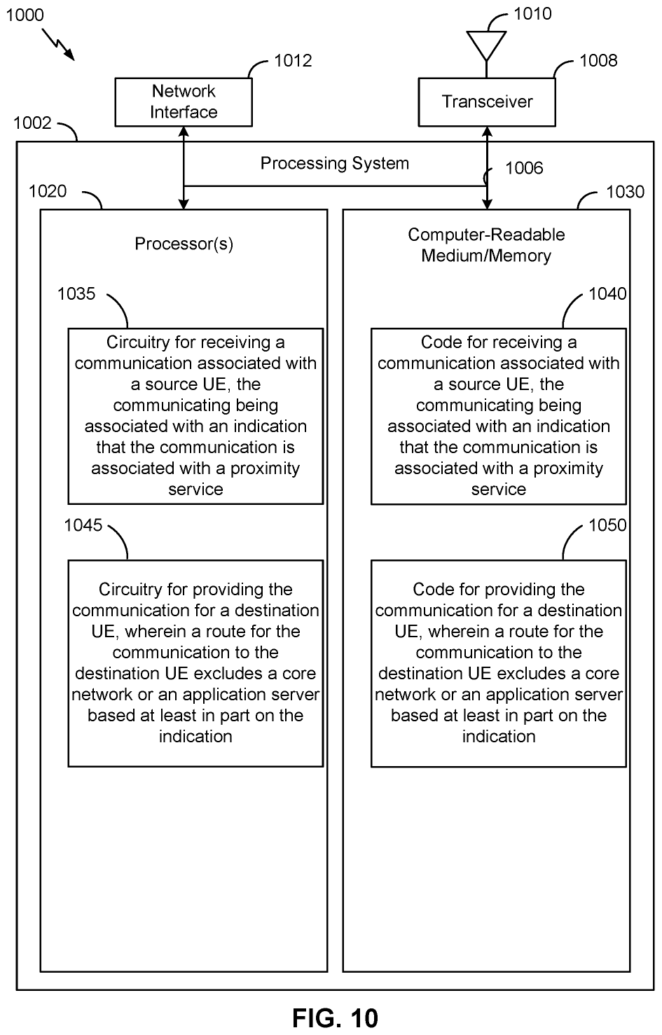

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

FIG. 9 is a diagram illustrating an example of an implementation of code and circuitry for a communications device 900, in accordance with the present disclosure. The communications device 900 may be a UE, or a UE may include the communications device 900.

The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes one or more processors 920. In various aspects, the one or more processors 920 may be representative of one or more of receive processor 258, transmit processor 264, TX MIMO processor 266, and/or controller/processor 280, as described with respect to FIG. 2. The one or more processors 920 are coupled to a computer-readable medium/memory 930 via a bus 906. In various aspects, the computer-readable medium/memory 930 may be representative of memory 282, as described with respect to FIG. 2. In certain aspects, the computer-readable medium/memory 930 is configured to store instructions (e.g., computer-executable code, processor-executable code) that when executed by the one or more processors 920, cause the one or more processors 920 to perform the method 700 described with respect to FIG. 7, or any aspect related to it. Note that reference to a processor performing a function of communications device 900 may include one or more processors performing that function of communications device 900.

As shown in FIG. 9, the communications device 900 may include circuitry for transmitting, to a network entity, a communication associated with an indication that the communication is associated with a proximity service (circuitry 935).

As shown in FIG. 9, the communications device 900 may include, stored in computer-readable medium/memory 930, code for transmitting, to a network entity, a communication associated with an indication that the communication is associated with a proximity service (code 940).

As shown in FIG. 9, the communications device 900 may include circuitry for communicating based at least in part on the proximity service (circuitry 945).

As shown in FIG. 9, the communications device 900 may include, stored in computer-readable medium/memory 930, code for communicating based at least in part on the proximity service (code 950).

Various components of the communications device 900 may provide means for performing the method 700 described with respect to FIG. 7, or any aspect related to it. For example, means for transmitting, sending, or outputting for transmission may include the transceiver(s) 254 and/or antenna(s) 252 of the UE 120 and/or transceiver 908 and antenna 910 of the communications device 900 in FIG. 9. Means for receiving or obtaining may include the transceiver(s) 254 and/or antenna(s) 252 of the UE 120 and/or transceiver 908 and antenna 910 of the communications device 900 in FIG. 9.

FIG. 9 is provided as an example. Other examples may differ from what is described in connection with FIG. 9.

FIG. 10 is a diagram illustrating an example of an implementation of code and circuitry for a communications device 1000, in accordance with the present disclosure. The communications device 1000 may be a network entity (such as BS 110 or a disaggregated base station as described with regard to FIG. 3), or a network entity may include the communications device 1000.

The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The network interface 1012 is configured to obtain and send signals for the communications device 1000 via communications link(s), such as a backhaul link, midhaul link, and/or fronthaul link as described herein, such as with respect to FIG. 3. The processing system 1002 may be configured to perform processing functions for the communications device 1000, including processing signals received and/or to be transmitted by the communications device 1000.

The processing system 1002 includes one or more processors 1020. In various aspects, the one or more processors 1020 may be representative of one or more of receive processor 238, transmit processor 220, TX MIMO processor 230, and/or controller/processor 240, as described with respect to FIG. 2. The one or more processors 1020 are coupled to a computer-readable medium/memory 1030 via a bus 1006. In various aspects, the computer-readable medium/memory 1030 may be representative of memory 242, as described with respect to FIG. 2. In certain aspects, the computer-readable medium/memory 1030 is configured to store instructions (e.g., computer-executable code, processor-executable code) that when executed by the one or more processors 1020, cause the one or more processors 1020 to perform the method 800 described with respect to FIG. 8, or any aspect related to it. Note that reference to a processor performing a function of communications device 1000 may include one or more processors performing that function of communications device 1000.

As shown in FIG. 10, the communications device 1000 may include circuitry for receiving a communication associated with a source UE, the communicating being associated with an indication that the communication is associated with a proximity service (circuitry 1035).

As shown in FIG. 10, the communications device 1000 may include, stored in computer-readable medium/memory 1030, code for receiving a communication associated with a source UE, the communicating being associated with an indication that the communication is associated with a proximity service (code 1040).

As shown in FIG. 10, the communications device 1000 may include circuitry for providing the communication for a destination UE, wherein a route for the communication to the destination UE excludes a core network or an application server based at least in part on the indication (circuitry 1045).

As shown in FIG. 10, the communications device 1000 may include, stored in computer-readable medium/memory 1030, code for providing the communication for a destination UE, wherein a route for the communication to the destination UE excludes a core network or an application server based at least in part on the indication (code 1050).

Various components of the communications device 1000 may provide means for performing the method 800 described with respect to FIG. 8, or any aspect related to it. For example, means for transmitting, sending, or outputting for transmission may include the transceiver(s) 232 and/or antenna(s) 234 of the BS 110 and/or transceiver 1008 and antenna 1010 of the communications device 1000 in FIG. 10. Means for receiving or obtaining may include the transceiver(s) 232 and/or antenna(s) 234 of the BS 110 and/or transceiver 1008 and antenna 1010 of the communications device 1000 in FIG. 10.

FIG. 10 is provided as an example. Other examples may differ from what is described in connection with FIG. 10.

The following provides an overview of some Aspects of the present disclosure:

Aspect 1: A method of wireless communication performed by a user equipment (UE), comprising: transmitting, to a network node, a communication associated with an indication that the communication is associated with a proximity service; and communicating based at least in part on the proximity service.

Aspect 2: The method of Aspect 1, wherein the indication comprises a packet type of the communication.

Aspect 3: The method of any of Aspects 1-2, wherein the indication comprises a medium access control or radio resource control layer indication.

Aspect 4: The method of any of Aspects 1-3, wherein the indication comprises a resource on which the communication is transmitted.

Aspect 5: The method of Aspect 4, further comprising receiving a configured grant indicating the resource.

Aspect 6: The method of any of Aspects 1-5, further comprising receiving a configuration of a resource pool; and transmitting the indication on a resource included in the resource pool.

Aspect 7: The method of any of Aspects 1-6, further comprising receiving information indicating a configuration for the indication.

Aspect 8: The method of Aspect 7, wherein the information indicating the configuration indicates at least one of: whether the network node is a regenerative satellite or a transparent satellite, whether the network node includes a central unit, whether local routing is supported for the proximity service, or a type of the local routing.

Aspect 9: The method of any of Aspects 1-8, wherein the indication includes a request for the network node to perform local routing of the communication.

Aspect 10: The method of any of Aspects 1-9, wherein the communication indicates a packet delay budget of the communication.

Aspect 11: The method of any of Aspects 1-10, wherein the indication comprises a buffer status request for a resource for the communication.

Aspect 12: A method of wireless communication performed by a network node, comprising: receiving a communication associated with a source UE, the communicating being associated with an indication that the communication is associated with a proximity service; and providing the communication for a destination UE, wherein a route for the communication to the destination UE excludes a core network or an application server based at least in part on the indication.

Aspect 13: The method of Aspect 12, wherein the network node comprises a satellite.

Aspect 14: The method of Aspect 13, wherein the satellite includes a distributed unit, and wherein providing the communication for the destination UE comprises providing the communication via a service link downlink of the satellite.

Aspect 15: The method of Aspect 13, wherein the satellite includes a central unit.

Aspect 16: The method of Aspect 13, wherein providing the communication comprises providing the communication on a downlink beam of the source UE.

Aspect 17: The method of Aspect 12, wherein the network node comprises a gateway.

Aspect 18: The method of Aspect 17, wherein receiving the communication further comprises receiving the communication on a feeder link, and wherein providing the communication further comprises providing the communication on the feeder link.

Aspect 19: The method of any of Aspects 12-18, wherein the indication comprises a packet type of the communication.

Aspect 20: The method of any of Aspects 12-19, wherein the indication comprises a medium access control (MAC) layer indication.

Aspect 21: The method of any of Aspects 12-20, wherein the indication comprises a resource on which the communication is transmitted.

Aspect 22: The method of Aspect 21, further comprising transmitting a configuration of a resource pool including the resource, wherein the resource pool is for transmission of the indication.

Aspect 23: The method of Aspect 21, further comprising transmitting a configured grant indicating the resource.

Aspect 24: The method of any of Aspects 12-23, further comprising transmitting, for the destination UE, a configured grant for reception of the communication.

Aspect 25: The method of any of Aspects 12-24, further comprising transmitting information indicating a configuration for the indication.

Aspect 26: The method of Aspect 25, wherein the information indicating the configuration indicates at least one of: whether the network node is a regenerative satellite or a transparent satellite, whether the network node includes a central unit, whether local routing is supported for the proximity service, or a type of the local routing.

Aspect 27: The method of any of Aspects 12-26, wherein the indication includes a request for the network node to perform local routing of the communication, wherein the route for the communication to the destination UE excludes the core network or the application server in accordance with the request.

Aspect 28: The method of any of Aspects 12-27, wherein the communication indicates a packet delay budget of the communication, wherein the route for the communication to the destination UE excludes the core network or the application server in accordance with the packet delay budget.

Aspect 29: The method of any of Aspects 12-28, wherein the communication as received by the network node and the communication as provided by the network node use a common waveform.

Aspect 30: The method of any of Aspects 12-29, wherein providing the communication further comprises providing the communication in accordance with a configured delay.

Aspect 31: The method of any of Aspects 12-30, wherein the indication comprises a buffer status report, wherein the method further comprises: receiving the buffer status report prior to the communication; and scheduling the source UE to transmit the communication in accordance with the buffer status report.

Aspect 32: An apparatus for wireless communication at a device, comprising a processor; memory coupled with the processor; and instructions stored in the memory and executable by the processor to cause the apparatus to perform the method of one or more of Aspects 1-31.

Aspect 33: A device for wireless communication, comprising a memory and one or more processors coupled to the memory, the one or more processors configured to perform the method of one or more of Aspects 1-31.

Aspect 34: An apparatus for wireless communication, comprising at least one means for performing the method of one or more of Aspects 1-31.

Aspect 35: A non-transitory computer-readable medium storing code for wireless communication, the code comprising instructions executable by a processor to perform the method of one or more of Aspects 1-31.

Aspect 36: A non-transitory computer-readable medium storing a set of instructions for wireless communication, the set of instructions comprising one or more instructions that, when executed by one or more processors of a device, cause the device to perform the method of one or more of Aspects 1-31.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,”“have,”“having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE) for wireless communication, comprising:
a memory; and
one or more processors, coupled to the memory, configured to:
transmit, to a network entity, a communication associated with an indication that the communication is associated with a proximity service; and
communicate based at least in part on the proximity service.

2. The UE of claim 1, wherein the indication comprises a packet type of the communication.

3. The UE of claim 1, wherein the indication comprises a medium access control or radio resource control layer indication.

4. The UE of claim 1, wherein the indication comprises a resource on which the communication is transmitted.

5. The UE of claim 4, wherein the one or more processors are further configured to receive a configured grant indicating the resource.

6. The UE of claim 1, wherein the one or more processors are further configured to receive a configuration of a resource pool; and
transmit the indication on a resource included in the resource pool.

7. The UE of claim 1, wherein the one or more processors are further configured to receive information indicating a configuration for the indication.

8. The UE of claim 7, wherein the information indicating the configuration indicates at least one of:
whether the network entity is a regenerative satellite or a transparent satellite,
whether the network entity includes a central unit,
whether local routing is supported for the proximity service, or
a type of the local routing.

9. The UE of claim 1, wherein the indication includes a request for the network entity to perform local routing of the communication.

10. The UE of claim 1, wherein the communication indicates a packet delay budget of the communication.

11. The UE of claim 1, wherein the indication comprises a buffer status request for a resource for the communication.

12. A network entity for wireless communication, comprising:
a memory; and
one or more processors, coupled to the memory, configured to:
receive a communication associated with a source UE, the communicating being associated with an indication that the communication is associated with a proximity service; and
provide the communication for a destination UE, wherein a route for the communication to the destination UE excludes a core network or an application server based at least in part on the indication.

13. The network entity of claim 12, wherein the network entity comprises a satellite.

14. The network entity of claim 13, wherein the satellite includes a distributed unit, and wherein providing the communication for the destination UE comprises providing the communication via a service link downlink of the satellite.

15. The network entity of claim 13, wherein the satellite includes a central unit.

16. The network entity of claim 13, wherein the one or more processors, to provide the communication, are configured to provide the communication on a downlink beam of the source UE.

17. The network entity of claim 12, wherein the network entity comprises a gateway.

18. The network entity of claim 17, wherein receiving the communication further comprises receiving the communication on a feeder link, and wherein providing the communication further comprises providing the communication on the feeder link.

19. The network entity of claim 12, wherein the indication comprises a packet type of the communication.

20. The network entity of claim 12, wherein the indication comprises a medium access control (MAC) layer indication.

21. The network entity of claim 12, wherein the indication comprises a resource on which the communication is transmitted.

22. The network entity of claim 21, wherein the one or more processors are further configured to transmit a configuration of a resource pool including the resource, wherein the resource pool is for transmission of the indication.

23. The network entity of claim 21, wherein the one or more processors are further configured to transmit a configured grant indicating the resource.

24. The network entity of claim 12, wherein the one or more processors are further configured to transmit, for the destination UE, a configured grant for reception of the communication.

25. The network entity of claim 12, wherein the one or more processors are further configured to transmit information indicating a configuration for the indication.

26. The network entity of claim 25, wherein the information indicating the configuration indicates at least one of:
whether the network entity is a regenerative satellite or a transparent satellite,
whether the network entity includes a central unit,
whether local routing is supported for the proximity service, or
a type of the local routing.

27. The network entity of claim 12, wherein the indication includes a request for the network entity to perform local routing of the communication, wherein the route for the communication to the destination UE excludes the core network or the application server in accordance with the request.

28. The network entity of claim 12, wherein the one or more processors, to provide the communication, are configured to provide the communication in accordance with a configured delay.

29. A method of wireless communication performed by a user equipment (UE), comprising:
transmitting, to a network entity, a communication associated with an indication that the communication is associated with a proximity service; and
communicating based at least in part on the proximity service.

30. A method of wireless communication performed by a network entity, comprising:
receiving a communication associated with a source UE, the communicating being associated with an indication that the communication is associated with a proximity service; and
providing the communication for a destination UE, wherein a route for the communication to the destination UE excludes a core network or an application server based at least in part on the indication.
